(19) United States
(12) Patent Application Publication
(10) Pub. No.: US 2006/0246924 A1
(43) Pub. Date: Nov. 2, 2006

(54) Method and apparatus for controlling paging delays of mobile stations in a wireless communication network

(75) Inventors: Srinivasan Balasubramanian, San Diego, CA (US); Ashutosh Aggarwal, San Diego, CA (US)

Correspondence Address: COATS & BENNETT, PLLC, P O BOX 5, RALEIGH, NC, 27602, US

(73) Assignee: Telefonaktiebolaget L M Ericsson (publ)

(21) Appl. No.: 11/120,001

(22) Filed: May 2, 2005

(51) Int. Cl. H04Q 7/20

(52) U.S. Cl. 455/459

(57) ABSTRACT

The page monitoring interval of a mobile station is configured according to a known or expected paging event probability, such that the mobile station, when idle, uses lower (faster) monitoring intervals at higher paging event probabilities. Page monitoring interval control information, such as in the form of one or more paging slot cycle index values, is sent to the mobile station in a connection release message, or in an idle-state message. The transmitted information effectively tailors the page-monitoring interval of the mobile station to a known or expected paging event probability function (e.g., a probability curve). The information may specify a minimum interval, e.g., a minimum reduced slot cycle index value, to be used at a time corresponding to a highest paging event probability. Paging event probabilities may be known or estimated based on the application type (e.g., Push-to-Talk), or based on activity tracking (e.g., call histories).

### BACKGROUND

The present invention generally relates to wireless communication networks, and particularly relates to controlling paging delays of mobile stations operating in such networks.

Idle mobile stations, i.e., mobile stations not actively connected to their supporting wireless communication networks, remain accessible for establishing new mobile-terminated connections based on their monitoring of paging channels, or other overhead and control channels. A typical paging channel comprises a number of paging channel slots, and an idle mobile station may monitor all paging channel slots (non-slotted mode), or a subset of those slots (slotted mode).

An idle mobile station that monitors all paging channel slots (continuous monitoring) exhibits a minimum paging response delay because it detects paging messages directed to it on any paging channel slot. The continuous monitoring configuration also provides the supporting network with maximum paging flexibility, since pages directed to the mobile station can be sent on any paging channel slot, rather than having to be scheduled for transmission on particular paging channel slots. However, continuous monitoring effectively requires the mobile station to leave its radio receiver and associated processing circuitry powered during the idle state, and thus reduces the battery life of the mobile station.

Slotted-mode operation addresses battery life concerns by allowing an idle mobile station to monitor a selected subset of paging channel slots, and to sleep or otherwise power down its receiver circuit during the intervals between the monitored subset of paging channel slots. In the IS-2000 standards applicable to cdma2000-based wireless communication networks, a Slot Cycle Index (SCI) value defines the monitoring interval of an idle mobile station operating in slotted mode. For example, with an 80-millisecond paging channel slot, the paging slot cycle of an idle mobile station can be configured to range from a minimum of 80 milliseconds to a maximum of 163.84 seconds.

Continuing with the above cdma2000 example, configurability of the mobile station's paging monitoring interval arises from the defining formula P=2ⁿ·1.28 seconds, where P represents the mobile station's configurable monitoring period, n represents a selectable SCI value, and 1.28 seconds represents a nominal slot cycle time (e.g., 16 slots of 80 milliseconds each). Selecting the value of n sets the paging slot cycle for the mobile station, where nε{−4,−3,−2,−1,0,1,2,3,4,5,6,7}. One sees that a setting of n=−4 achieves the minimum monitoring interval, while a setting of n=7 achieves the maximum monitoring interval.

The relevant literature commonly refers to a negative value of n as a Reduced Slot Cycle Index (RSCI), because any SCI value less than zero defines a monitoring interval that is less than the nominal interval of 1.28 seconds given in the above formula. However, any SCI value that is less than a network- or mobile-defined default value may be considered as a reduced value. The term SCI is used herein to refer to any slot cycle index value in a defined range of values, but it should be understood that index values below a default value are regarded as RSCI values whether or not the RSCI term is used within the text.

The need for reduced paging slot cycles arises primarily because some types of applications, particularly many of the newer data services, require idle mobile stations to be reconnected to the network with minimum delays. The longer paging slot cycle settings are incompatible with these kinds of services, and mobile stations engaged in such applications generally must be configured to use a SCI that yields an appropriately short monitoring interval. However, setting the monitoring interval of a given mobile station lower than necessary for its applications' needs unnecessarily compromises the mobile station's battery life. Moreover, the network's scheduling difficulties increase when significant numbers of the mobile stations being supported by it operate on reduced paging slot cycles.

The IS-2000 standards define mechanisms for adjusting the SCIs of mobile stations. More specifically, the standards provide a mechanism for setting a mobile station's SCI as part of the connection release process. A default SCI value can be configured as part of the connection release, and a different SCI (i.e., RSCI) can be specified for a temporary time frame, such that the mobile station initially operates on a reduced paging slot cycle after the connection release, and then reverts back to its default paging slot cycle.

Further refinements have been proposed that go beyond the basic provisions of the standards. For example, one proposal suggests the use of a programmed decay, wherein a mobile station steps through a number of reduced paging slot cycle settings after connection release, before reverting to a default paging slot cycle setting. Each successive paging slot cycle setting specifies a longer paging slot cycle, so the mobile station's paging response is fastest immediately after call release, and becomes progressively slower, until the mobile station finally reverts to its default SCI value.

While the various approaches outlined immediately above do provide limited configurability of paging slot cycles, they leave a number of challenges unaddressed. For example, no existing approach addresses the fact that the most appropriate paging slot cycle setting may change over time. More particularly, none of the existing approaches to managing paging delays provides a mechanism for tailoring the paging delay of a mobile station according to paging event probabilities.

### SUMMARY OF THE DISCLOSURE

A base station or other entity in a wireless communication network includes a page monitoring interval controller that configures a mobile station to operate with lower (faster) page monitoring intervals at times corresponding to higher paging event probabilities. In at least one embodiment, paging event probabilities are determined from known or expected incoming data arrival probabilities. In this manner, a mobile station may be programmed to operate with lower page monitoring intervals at times corresponding to higher incoming data arrival probabilities, such that the mobile station exhibits lower paging delays during such times.

In one embodiment, a base station or other entity within a wireless communication network implements a method of controlling a paging delay of a mobile station, wherein the method comprises configuring the mobile station to operate with lower page monitoring intervals at times corresponding to higher paging event probabilities. More broadly, the mobile station can be configured to use page monitoring intervals tailored to the paging event probabilities expected or known for the mobile station as a function of the application type, e.g., Push-to-Talk services, web-based “Push” services, etc., and/or as a function of tracking call activity for the particular mobile station, or for all or a portion of the network.

In cdma2000-based wireless communication networks, and in other network types that define slotted paging channels, the page monitoring intervals of mobile stations may be set using Slot Cycle Index (SCI) values. In such systems, the SCI value used by a mobile station defines the paging channel monitoring frequency of the mobile station. Thus, the network may configure the SCI values used by the mobile station such that the mobile station operates with a lower page monitoring interval at higher paging event probabilities (i.e., faster page monitoring), and a higher page monitoring interval at lower paging event probabilities (i.e., slower page monitoring).

Thus, in one embodiment, the method comprises determining a page monitoring profile for a mobile station according to a known or expected paging event probability, and transmitting a message to the mobile station, including information regarding the monitoring profile. The monitoring profile may comprise one or more paging slot cycle index values that set a paging slot cycle of the mobile station, wherein the one or more paging slot cycle index values include a minimum paging slot cycle index value corresponding to a time of highest paging event probability. With this method, the mobile station may be configured to operate with a minimum page monitoring interval at a time corresponding to a highest paging event probability. In this context, “minimum” does not necessarily mean the lowest defined interval (e.g., the lowest defined SCI value), but rather the lowest relative value used by the mobile station.

In one embodiment, the page monitoring information sent to the mobile station comprises a monitoring interval profile fitted to a paging event probability curve, such that the mobile station's page monitoring interval changes over time subsequent to a connection release, or subsequent to transmission of the monitoring interval profile, in accordance with the paging event probability curve. The monitoring interval profile may comprise a set of SCI values (and corresponding times or time offsets), that tell the mobile station which page monitoring interval to use at which times.

By way of non-limiting example, the monitoring interval profile can comprise a single SCI value, representing a minimum monitoring interval. The mobile station can implement the specified minimum monitoring interval upon connection release (or upon receiving the message), or can implement it at a time specified or otherwise controlled by additional information in the message (e.g., a time offset value). As another example, the monitoring interval profile may comprise two or more SCI values, and the values may represent different time points or windows along a paging event probability function. That is, the known or expected paging event probability function associated with the mobile station may be plotted in time, and appropriate SCI values taken from that plot.

Of course, the present invention is not limited by the foregoing summary of selected features and advantages. Those skilled in the art will recognize additional features and advantages upon reading the following description, and upon viewing the accompanying drawings.

### BRIEF DESCRIPTION OF THE DRAWINGS

FIG. 1 is a block diagram of a wireless communication network.

FIG. 2 is a diagram of a slotted paging channel.

FIG. 3 is a logic flow diagram illustrating processing logic to support idle mobile station page monitoring interval control as a function of paging event probability.

FIG. 4 is a diagram of a page monitoring interval control message.

FIG. 5 is a diagram of a paging event probability function, and corresponding page monitoring interval settings (Slot Cycle Index values).

FIG. 6 is a state diagram of page monitoring interval control messaging relative to active and idle connection states of a mobile station.

FIG. 7 is a block diagram of Base Station Controller (BSC), Radio Base Station (RBS), and mobile station functional details in support of one embodiment of page monitoring interval control as a function of paging event probabilities.

### DESCRIPTION OF EMBODIMENTS OF THE INVENTION

The following detailed description offers a number of non-limiting examples of controlling the page monitoring interval of a mobile station, such that the mobile station operates with lower page monitoring intervals at times corresponding to higher paging event probabilities. As used herein, the term “paging event probability” denotes the probability that a supporting wireless communication network will need to page a given mobile station, for the transfer of signaling information and/or data to the mobile station. Thus, the paging event probability is higher at times the network knows it must deliver control information and/or data to the network, or at times when it expects that it will need to make such deliveries.

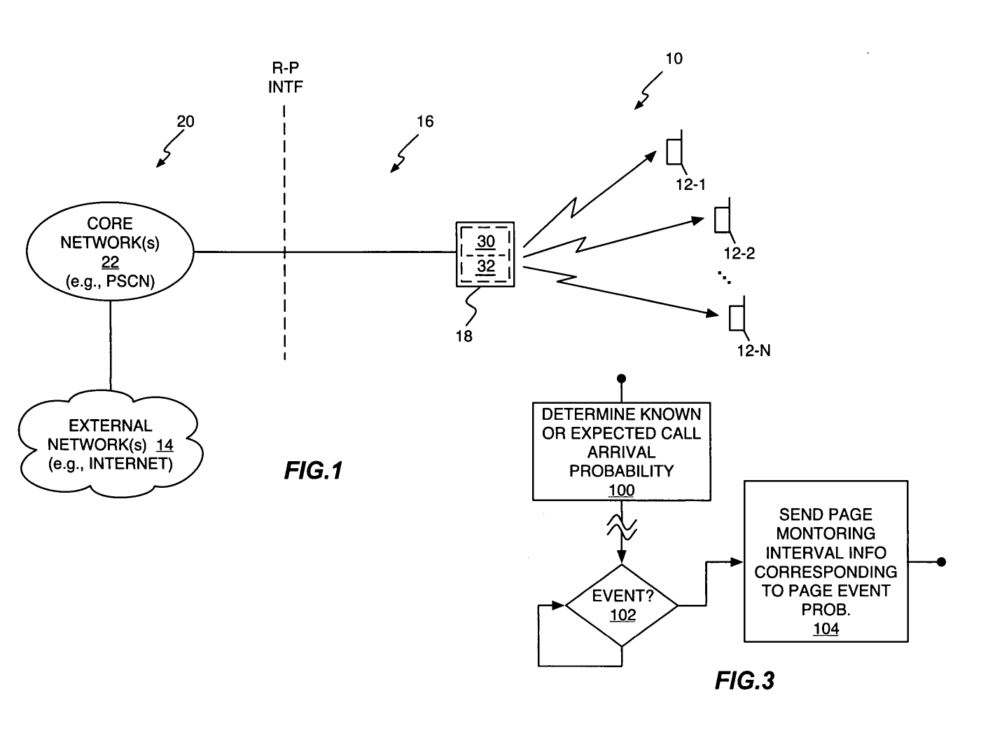

With the above in mind, FIG. 1 illustrates, by way of non-limiting example, a portion of a wireless communication network 10, which may be configured as a cdma2000 network, for example, according to the IS-2000 and other relevant standards. However, it should be understood that the network 10 may be configured according to other standards, such as the Wideband Code Division Multiple Access (W-CDMA) standards, or the High Data Rate (HDR) standards associated with 1xEV-DO networks.

Regardless of the particular protocols and standards adopted for it, fundamentally, the network 10 communicatively couples a potentially large number of mobile stations 12 to one or more external networks 14. By way of non-limiting example, the external network(s) 14 include the Internet, or other Public Data Networks (PDNs). In the network 10, a Radio Access Network (RAN) 16 provides wireless signaling to and from the mobile stations 12, and provides the Radio-Packet (R-P) interface between the mobile stations 12 and the Core Network(s) (CNs) 22, which may comprise a Packet Switched Core Network (PSCN), to support packet data communication between targeted ones of the mobile stations 12 and servers, systems, or other devices that are accessible through the external network(s) 14.

In turn, the illustrated RAN 16 comprises one or more Base Stations (BSs) 18, which interface with CNs 22 via one or more backhaul links, which may comprise land lines, wireless links, etc. The BS(s) 18 also interface with the mobile stations 12 via wireless signaling, according to the applicable network standards and air interface protocols. Note that the plural term “mobile stations 12” is used herein generically to refer to any number of mobile stations and the singular term “mobile station 12” is used generically to refer to any one mobile station, while the term “mobile station 12-x” is used specifically to refer to a particular mobile station, such as 12-1, 12-2, and so on.

In operation, the network 10 sets up and tears down data connections, as needed in support of mobile-terminated and mobile-originated packet data calls. Many types of packet data traffic are intermittent by nature. For example, if the user of a given mobile station 12 is browsing the World Wide Web, that user's data connection may be active only during the times when the user clicks a new hypertext link. In between clicks, the connection carries no traffic and therefore is considered idle. It is known to release at least some of the communication resources allocated to idle connections so that those resources can be allocated to active data connections. For example, the radio resources allocated to an idle data connection may be torn down and reallocated. (This reallocation allows the network 10 to support a greater number of “simultaneous” data users.)

Of course, the start/stop nature of many data applications implies that the network 10 should have a mechanism for restarting an idle data connection without undue delay. In particular, the network 10 should have a mechanism for transitioning a targeted mobile station 12 from the idle connection state back to the active connection state for timely delivery of mobile-terminated data. Assuming that the mobile station's dedicated channels have been torn down as part of idle-state processing, the conventional solution is for the network 10 to send paging messages to the targeted mobile station 12. This paging action works because the mobile stations 12 generally are programmed to monitor one or more common (shared) channels while in the idle state. Such channels may be explicit paging channels, common control channels, or other types of overhead channels, and all such channels are generically referred to herein as paging channels.

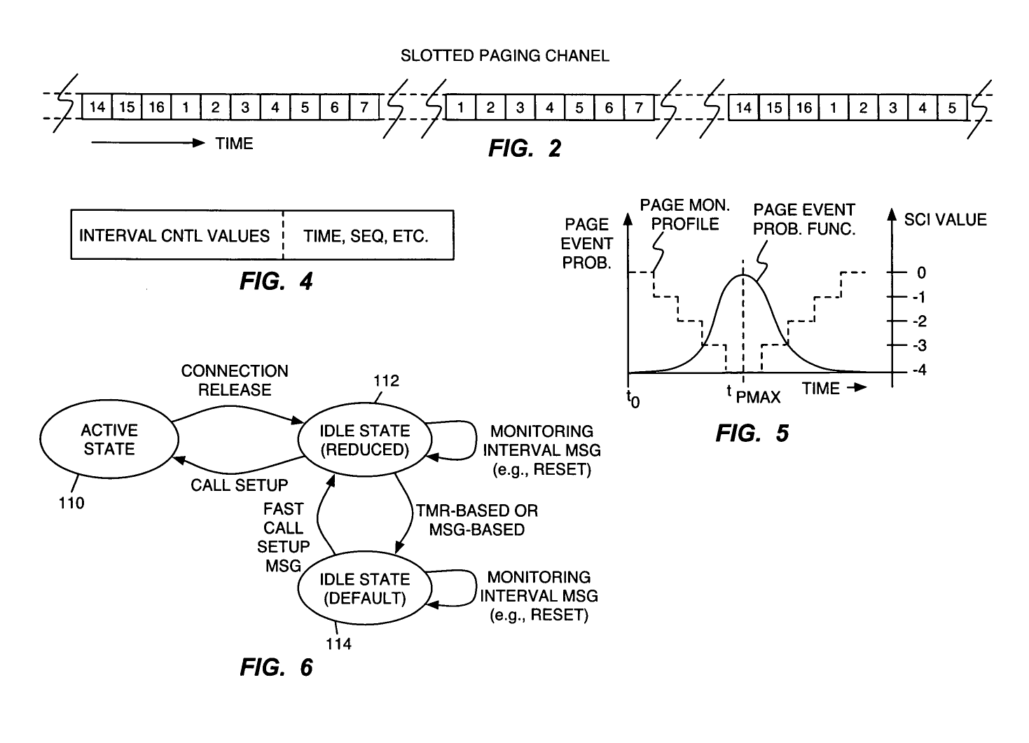

FIG. 2 illustrates one embodiment of a paging channel such as might be transmitted in a cdma2000-based embodiment of the network 10 or in any other embodiment of the network 10 that uses “slotted” paging channels. One sees that the paging channel is divided logically into successive time slots, e.g., 80 millisecond slots. Each slot may be considered as a separate paging channel inasmuch as different paging messages targeted to different mobile stations 12 can be sent in each paging channel slot. A defined sequence of slots, e.g., slots 1-16, may be “repeated” over and over, such that transmission of the paging channel comprises the repeating transmission of paging slot cycles. Using the 80-millisecond slot timing and 16-slot cycle values, the paging channel illustrated in FIG. 2 has a base paging slot cycle of 1.28 seconds (16 slots×80 milliseconds/slot).

An idle mobile station 12 may monitor all slots of the paging channel and thereby exhibit a minimum paging delay response, i.e., the network 10 can be assured that the mobile station 12 is listening to the paging channel on a continuous basis and thus can send a page for that mobile station 12 on the paging channel whenever incoming traffic is received for that mobile station 12. However, continuous monitoring tends to drain the mobile station's battery.

To allow for better battery life, the network 10 and the mobile stations 12 are configured to support slotted operation, wherein the mobile stations 12 monitor specified subsets of the paging channel slots according to a specified monitoring interval. Since slotted operation means the mobile stations 12 monitor only selected ones of the paging channel slots, mobile stations 12 operating in slotted mode exhibit a potential paging response delay since paging messages for those mobile stations 12 can be sent only during the times they actually are monitoring the paging channel.

However, according to the methods taught herein, and in contrast to conventional slotted mode operation, a given mobile station 12 may be configured to operate in slotted mode while exhibiting minimal paging delay response, at least during idle times that correspond to higher paging event probabilities. FIG. 3 outlines one embodiment of the slotted operation methods taught herein, wherein the BS 18, or some other entity within the network 10, determines a known or expected paging event probability for a given mobile station 12 or for a given group of mobile stations 12 (Step 100).

The BS 18 (or other entity) uses the information to determine an appropriate page monitoring interval for the mobile station(s) 12 such that the mobile station(s) 12 are configured to use lower page monitoring intervals at a time (or times) corresponding to higher paging event probabilities. In referring to FIG. 2, the BS 18 may include control and processing circuits, e.g., microprocessors and software, which include or are associated with a page monitoring interval controller 32 that is configured to determine page interval monitoring information for given mobile stations 12 as a function of paging event probabilities. (For embodiments where mobile stations page monitoring intervals are controlled using SCI values, the controller 32 may be considered as a “SCI controller.”)

For example, the BS 18 may determine a page monitoring interval profile that maps one or more page monitoring interval settings against a paging event probability function, e.g., curve. Generally, the page monitoring interval information is sent in response to a defined event (Step 102) in the form of a message transmitted to the intended mobile station(s) 12 (Step 103). Non-limiting examples of such events comprise the BS 18 determining that the paging event probabilities for a given mobile station 12 have changed, or as part of connection release processing, wherein the mobile station's connection is being released as part of transitioning the mobile station 12 to an idle connection state. For cdma2000 embodiments, the page monitoring interval control information message may be sent as an enhanced connection release message via Level 3 (L3) signaling carried out between the BS 18 and the mobile station 12.

FIG. 4 illustrates one embodiment of a page monitoring information message, which comprises one or more page monitoring interval settings and which may further comprise corresponding time or sequence values that indicate which of the interval settings the mobile station 12 should use at what times. A mobile station 12 may be configured to follow a page monitoring profile immediately after a connection release, immediately after receipt of the profile during idle-state operation, or at other programmed times. Thus, the mobile station 12 can be configured to change its page monitoring interval over a window of time defined according to some relative or absolute reference time such that its page monitoring interval follows a paging event probability curve that is known or expected for that window of time.

In terms of controlling the page monitoring interval, it was noted earlier herein that the cdma2000 standards provide a mechanism for controlling the page monitoring intervals of mobile stations 12 based on the use of Slot Cycle Index (SCI) values. A given mobile station 12 monitors the paging channel at a period, P, wherein the period is defined by the equation P=2ⁿ·1.28 seconds, n represents a selectable SCI value, 1.28 seconds represents a nominal slot cycle time (e.g., 16 slots of 80 milliseconds each), and the defined index values are nε{−4,−3,−2,−1,0,1,2,3,4,5,6,7}.

Thus, with these defined values, the page monitoring interval of individual mobile stations 12 may be set from a minimum of 80 milliseconds (n=−4), to a maximum of 163.84 seconds (n=7). FIG. 5 illustrates how the methods taught herein extend the mechanisms defined by the IS-2000 standards, but it should be understood that such teachings extend to other network standards and system types that provide for configurable page monitoring intervals.

The graph in FIG. 5 plots paging event probability as a function of time, where paging event probability is denoted on the left vertical axis. The graph also plots example SCI values as a function of the changing paging event probability, and one sees that SCI values are indicated on the right vertical axis. More specifically, the example paging event probability function comprises a bell-shaped curve having a maximum paging event probability at time t_{MAX} positioned at some time offset from time t₀. The SCI values graphed range from a starting value (e.g., immediately subsequent to t₀) of −1, which steps down to −2, −3, to a minimum of −4, and then steps back up to an ending value of 0.

Monitoring interval information, such as individual SCI values, can be mapped to paging event probability curves of essentially any shape and duration. Further, the paging event probability curve may be based on known paging event times, or based on expected paging event probability times. As explained later herein, some types of packet data applications exhibit specific characteristics in terms of idle-state paging event probabilities so that a paging event probability can be learned or estimated for given types of packet data applications. Such details are explained more fully later herein.

Also, note that any SCI number and range of SCI values can be used to define a desired page monitoring interval profile for a given mobile station 12, and that the set of SCI values need not include a “final” ending value. No per se ending value is need because the mobile station 12 can revert to a default, non-reduced SCI value after operating at each of the specified SCI values for the specified times. Further, it is not necessary for the page monitoring interval profile to be symmetrical, and different SCI values (and numbers of SCI values) can be used on either side of the highest paging event probability point. Also, note that the reference time to may represent a connection release event, or may represent the receipt of an idle-state page monitoring information message. Additionally, the page monitoring information message itself may specify the time t₀.

FIG. 6 illustrates one embodiment of page monitoring interval timing by way of a connection state diagram, wherein a mobile station 12 is transitioned from the active state 110 to a first idle state 112, and, possibly, between the idle state 112 and another idle state 114. In the illustration, the idle state 112 corresponds to idle state operation using a page monitoring interval that is faster than a default page monitoring interval (i.e., a “reduced” state), and the idle state 114 corresponds to idle state operation using a non-reduced page monitoring interval (i.e., a “default” state).

From the diagram, one sees that the network 10 may send page monitoring interval control information to a given mobile station 12 as part of the connection release message (i.e., an enhanced connection release message), or at any time the mobile station 12 is operating in the one of the idle states 112 and 114. That is, the network 10 may use one of the channels monitored by the mobile station 12 while the mobile station 12 is idle to send updated or changed page monitoring interval control information.

In general, then, the network 10 may configure the mobile station 12 to operate with lower page monitoring intervals at times corresponding to higher paging event probabilities by transferring a number of paging slot cycle index values to the mobile station 12, and information identifying times for operating at each one of the number of paging slot cycle index values. In such cases, the number of paging slot cycle index values and times correspond to known or expected paging event probabilities. Further, as indicated by the state diagram of FIG. 6, the network 10 may transfer page monitoring interval configuration information to the mobile station 12 in association with releasing a connection of the mobile station 12, or while the mobile station 12 is in an idle state.

Regardless of whether the message is sent as a part of connection release, or while the mobile station 12 is idle, an example of the page monitoring interval control information sent from the network 10 to the targeted mobile station(s) 12 thus comprises a set of SCI values and corresponding time offsets (refer back to the example message of FIG. 4). This information may be thought of as a form of page monitoring profile, which represents points plotted from the paging event probability curve. One sees that this arrangement allows the network 10 to tailor the particular page monitoring interval of a given mobile station 12 to speed up or slow down as a function of paging event probability.

More particularly, the method allows the network 10 to configure targeted mobile station(s) 12, such that their page monitoring intervals are lower for higher paging event probabilities. For example, the SCI value corresponding to the highest paging event probability generally is the minimum SCI value in the set of SCI values. In one embodiment, a single SCI value can be sent for use by the mobile station(s) 12 at a specified time corresponding to an expected highest paging event probability. Alternatively, as shown, multiple SCI values may be sent, so that the mobile stations' page monitoring intervals can be made to stepwise follow essentially any paging event probability curve.

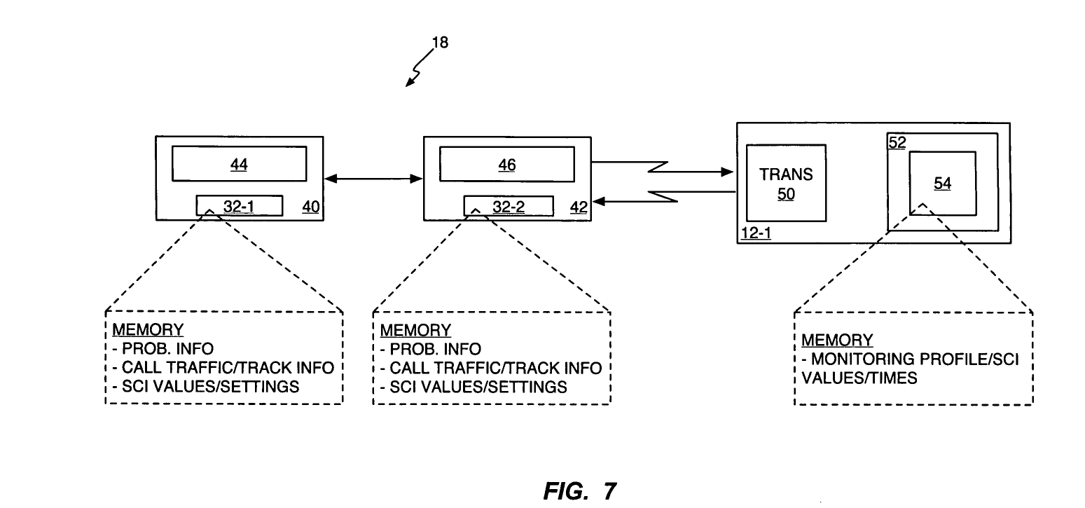

FIG. 7 illustrates one embodiment of a BS 18, comprising a Base Station Controller (BSC) 40 and a Radio Base Station (RBS) 42. The BSC 40 comprises communication and control circuits 44 that include or are associated with a page monitoring interval controller 32-1. In at least one embodiment, the communication and control circuits 44 comprise one or more microprocessors running appropriately configured computer program instructions (software). More generally, those skilled in the art will appreciate that the BSC 40 may be configured using any combination of hardware and software, and that the controller 32-1 likewise may comprise hardware, software, or some combination thereof.

The controller 32-1 may handle all of the page monitoring interval control functions described in any of the above embodiments, or such tasks may be performed in whole or in part by the RBS 42, which includes communication and control circuits 46. In such embodiments, the RBS 42 includes a page monitoring interval controller 32-2, which may comprise a portion of the control and communication circuits 46. As with the page monitoring interval controller 32-1, the controller 32-2 may comprise hardware, software, or any combination thereof.

Thus, it may be appreciated that the page monitoring interval control methods described herein may be partly or wholly carried out by a given entity within the network 10, or carried out cooperatively by two or more entities. In at least one embodiment, there may be advantages to consolidating page monitoring interval control at the BSC 40, because that node has knowledge of the different applications being run by different ones of the mobile stations 12, being supported by the one or more RBSs 42 controlled by the BSC 40. As such, the BSC 40 represents a convenient node for consolidating the page monitoring interval control of the potentially large number of mobile stations 12 that are directly or indirectly being supported by the BSC 40.

Regardless of where the page monitoring interval control resides in the network, the mobile stations 12 generally are configured to operate according to the page monitoring information received from the network 10. FIG. 7 illustrates one embodiment of a particular mobile station 12-1 by way of non-limiting example. As illustrated, the mobile station 12-1 comprises transceiver circuits 50 (e.g., RF receiver and transmitter circuits), and baseband/control circuits 52, which include or are associated with a control circuit 54 that provides page monitoring interval control responsive to the page monitoring information received from the network 10 in the message(s) described above.

With the embodiments illustrated in FIG. 7, the page monitoring interval controller 32-1 includes or is associated with memory for storing paging event probability information for one or more mobile stations 12, call activity and/or traffic tracking information, monitoring interval settings and information (SCI values, etc.). All or a part of the same information can be stored in the RBS 42, in embodiments where the RBS 42 includes controller 32-2.

Although such details support one or more specific embodiments of page monitoring interval control, it should be understood that page monitoring interval control as taught herein more broadly comprises a method of controlling the paging delays of one or more mobile stations 12 based on configuring the mobile station(s) 12 to operate (at least temporarily) with lower page monitoring intervals at times corresponding to higher paging event probabilities.

In one or more specific embodiments, the method may comprise the BS 18 sending a monitoring interval profile to one or more targeted mobile stations 12, such that the mobile stations' page monitoring intervals changes over time subsequent to a connection release, for example, in accordance with the paging event probability curve. Sending the monitoring interval profile may comprise sending a set of SCI values that are determined according to the paging event probability curve.

On that point, the BS 18 (or other entity within the network 10) may be configured to determine the appropriate paging event probability curves for one or more mobile stations 12 as a function of an application type(s) associated with the mobile stations 12. Of course, the network 10 may update the page monitoring interval information and/or the paging event probability for individual mobile stations 12, or groups of mobile stations 12, as the application types associated with those mobile stations 12 changes over time.

By way of non-limiting example, a given mobile station 12 may be engaged in a Push-to-Talk (PTT) service, wherein the mobile station 12 is idle between receiving or sending PTT traffic. In such instances, the mobile station 12 generally must exhibit a low paging delay response, so that the mobile station's idle connection can be reactivated for the timely delivery of newly arriving PTT traffic targeted to the mobile station 12.

In one or more embodiments of page monitoring interval control, it is desired to maintain a half-second reactivation response for a mobile station 12 engaged in a PTT application, for the first five seconds after termination of each PTT traffic event. Thus, the BS 18 or other network entity may be configured to send a page monitoring profile to the mobile station 12 as part of a first connection release event, or as part of each connection release event, to program the mobile station 12 to use a reduced monitoring interval over this window. More particularly, the page monitoring profile may be configured so that the mobile station 12 monitors more and more frequently as a timer from the last PTT event ticks toward the five-second mark, and then begins monitoring less and less frequently once that mark is passed. Such tailored monitoring may be carried out after each PTT event.

Thus, for PTT applications, determining that the highest paging event probability may comprise determining that the highest arrival probability lies within a defined interval after each PTT call connection release, possibly according to a known or expected probability curve.

As another non-limiting example, a given mobile station 12 may be involved in a “Push” type application involving the timed delivery of packet data to the mobile station 12. Such push services commonly comprise stock tickers, news streamers, weather/flight updaters, etc. With Push Services (PS) application types, determining the time of highest paging event probability may be based on determining that the highest paging event probability occurs at a known or observed PS transmission interval. In other words, the PS application may be configured with a defined push interval, e.g., new data is pushed every 10 seconds, and the page monitoring profile for the mobile station 12 can be configured accordingly.

For example, using the 10-second value from above, the page monitoring interval control information sent to the mobile station 12 generally should comprise at least one SCI value corresponding to a minimum page monitoring interval to be used by the mobile station 12 at the 10-second time window, such that the mobile station 12 exhibits low page response delay at the time the next push event is expected. Thus, the mobile station 12 could be configured to use a relatively slow page-monitoring interval during the first nine seconds after a push event connection release, and then switch to the fast page-monitoring interval at the nine-second mark. The mobile station 12 also could be programmed by the received page monitoring interval control information to revert back to a slower page-monitoring interval if no push event occurs by the 11-second mark, for example.

In addition to determining paging event probabilities as a function of the application type(s) associated with mobile stations 12, or as an alternative to that approach, the network 10 can be configured to determine a paging event probability for given mobile stations 12 as a function of tracking call activity for the mobile station(s) 12. Tracking can be based on short-term tracking, e.g., last hour, last day, etc. Additionally, or alternatively, for a given mobile station 12, tracking can be based on developing a historical profile for the mobile station 12 that indicates the times of day during which the mobile station 12 is most active.

For example, a given mobile station user may receive most incoming calls during weekday lunch hours, or in the evenings after a defined hour (such as the start of reduced-rate or free calling periods). In such cases, the network 10 effectively can “learn” the times when the mobile station 12 is more likely to receive incoming calls, and can configure the mobile station 12 to use reduced page monitoring intervals during those times. Since historical call tracking based on individual mobile station calling patterns is a function of the individual behavior of each mobile station user (subscriber), such information can be stored in a Home Location Register (HLR) of the network 10, or stored in a dedicated database server in the network 10, or accessible by the network 10. Such information can then be obtained by any BS 18 for use in setting the page monitoring intervals of mobile stations 12 for which tracking information is available.

In addition to tracking individual subscriber call activities, or as an alternative to such tracking, the network 10 may be configured to determine paging event probabilities for given mobile stations 12 as a function of tracking call activity for the network 10, or for selected entities within the network 10. For example, the network 10, or individual entities within the network 10, may track Busy Hour Call Attempt (BHCA) information and/or other indicators of changing call activity levels, and use such information to predict paging event probabilities for individual mobile stations 12 and/or groups of mobile stations 12. Tracking based on network activity may be performed on a per-BS basis, i.e., with each BS 18 tracking its own activity over hours, or days, or weeks, etc., and making BS-specific paging event probability determinations. Alternatively, tracking may be done across one or more BSs 18, such as for all BSs 18 serving a particular geographic region. In that manner, paging event probabilities can be determined (estimated) based on the calling patterns observed in specific regions, e.g., a downtown city area.

Of course, other tracking mechanisms could be used to develop paging event probability information, and some embodiments of the page monitoring interval control methods taught herein may use such other methods, or may not use any call tracking. Indeed, some embodiments of the methods taught herein may base paging event probability information based on provisioned (configured) information corresponding to particular application types, or may “learn” average or typical paging event probabilities for such applications, or may be provided such information by other means. In any case, the present invention is not limited by such details.

More generally, those skilled in the art should appreciate that the present invention is not limited by the foregoing discussion or by the accompanying drawings. Indeed, the present invention is limited only by the following claims and their legal equivalents.

What is claimed is:

1. A method of controlling a paging delay of a mobile station comprising configuring the mobile station to operate with lower paging intervals at times corresponding to higher paging event probabilities.

2. The method of claim 1, wherein configuring the mobile station to operate with lower paging intervals at times corresponding to higher paging event probabilities comprises configuring the mobile station to operate with a minimum paging interval at a time corresponding to a highest paging event probability.

3. The method of claim 1, wherein configuring the mobile station to operate with lower paging intervals at times corresponding to higher paging event probabilities comprises sending one or more monitoring interval settings to the mobile station that specify a minimum monitoring interval to be used by the mobile station at a time corresponding to a highest paging event probability.

4. The method of claim 1, further comprising determining paging event probabilities for the mobile station as a function of known or expected incoming data arrival probabilities.

5. The method of claim 4, further comprising determining incoming data arrival probabilities based on an application type associated with the mobile station.

6. The method of claim 5, wherein determining incoming data arrival probabilities based on an application type associated with the mobile station comprises, for a Push-To-Talk (PTT) application, determining that a highest probability of a new PTT event occurs at a defined time offset after a last PTT event.

7. The method of claim 5, wherein determining incoming data arrival probabilities based on an application type associated with the mobile station comprises, for a Push Services (PS) application, determining that a highest probability of a new PS event occurs at known or expected PS data delivery times.

8. The method of claim 1, wherein configuring the mobile station to operate with lower paging intervals at times corresponding to higher paging event probabilities comprises sending a monitoring interval profile to the mobile station, said monitoring interval profile comprising one or more monitoring interval settings that map to an incoming data arrival probability curve associated with the mobile station.

9. The method of claim 8, further comprising generating the monitoring interval profile as a set of monitoring interval values mapped to the incoming data arrival probability curve, such that the mobile station's page monitoring interval changes over time as a function of the incoming data arrival probability curve.

10. The method of claim 1, wherein configuring the mobile station to operate with lower page monitoring intervals at times corresponding to higher paging event probabilities comprises transferring a number of paging slot cycle index values to the mobile station, and information identifying times for operating at each one of the number of paging slot cycle index values, and wherein the number of paging slot cycle index values and times correspond to known or expected paging event probabilities.

11. The method of claim 1, further comprising determining times corresponding to higher paging event probabilities based on tracking call activity for the mobile station, for a base station supporting the mobile station, or for one or more selected entities in network supporting the mobile station.

12. The method of claim 1, wherein configuring the mobile station to operate with lower page monitoring intervals at times corresponding to higher paging event probabilities comprises transferring page monitoring interval configuration information to the mobile station in association with releasing a data connection of the mobile station.

13. The method of claim 1, wherein configuring the mobile station to operate with lower page monitoring intervals at times corresponding to higher paging event probabilities comprises transferring page monitoring interval configuration information to the mobile station while the mobile station is in an idle state.

14. A method of configuring a mobile station to operate with lower page monitoring intervals at times corresponding to higher paging event probabilities comprising:
determining a page monitoring profile for the mobile station according to a known or expected paging event probability; and
transmitting a message to the mobile station, including information regarding the page monitoring profile;
said page monitoring profile comprising one or more paging slot cycle index values that set a paging slot cycle of the mobile station, and wherein the one or more paging slot cycle index values include a minimum paging slot cycle index value corresponding to a time of highest paging event probability.

15. A base station for use in a wireless communication network, said base station comprising a page monitoring interval controller configured to generate page monitoring interval control information for a mobile station, such that the mobile station operates with lower paging intervals at times corresponding to higher paging event probabilities.

16. The base station of claim 15, wherein the base station comprises a base station controller adapted to control a number of radio base stations, and wherein the page monitoring interval controller is configured to generate page monitoring interval control information for mobile stations supported by any one or more of the radio base stations.

17. The base station of claim 15, wherein the base station comprises a radio base station adapted to support a plurality of mobile stations via wireless signaling and wherein the page monitoring interval controller is configured to generate page monitoring interval control information for mobile stations supported by the radio base station.

18. The base station of claim 15, wherein the page monitoring interval controller is configured to generate a monitoring interval profile according to a paging event probability function, such that the mobile station's page monitoring interval changes over time in accordance with the paging event probability function.

19. The base station of claim 15, wherein the page monitoring interval controller is configured to generate the page monitoring interval control information as a set of paging slot cycle index values for transmission to the mobile station in a connection release message or in an idle-state message.

20. The base station of claim 15, wherein the page monitoring interval controller is configured to generate the page monitoring interval control information, such that the mobile station to operate with a minimum paging interval at a time corresponding to a highest paging event probability.

21. The base station of claim 15, wherein the page monitoring interval control information specifies a minimum monitoring interval to be used by the mobile station at a time corresponding to a highest paging event probability.

22. The base station of claim 15, wherein the page monitoring interval controller is configured to determine paging event probabilities for the mobile station as a function of known or expected incoming data arrival probabilities.

23. The base station of claim 22, wherein the page monitoring interval controller is configured to determine incoming data arrival probabilities based on an application type associated with the mobile station.

24. The base station of claim 23, wherein, for a Push-To-Talk (PTT) application, the page monitoring interval controller is configured to determine that a highest probability of a new PTT event occurs at a defined time offset after a last PTT event.

25. The base station of claim 23, wherein, for a Push Services (PS) application, the page monitoring interval controller is configured to determine that a highest probability of a new PS event occurs at known or expected PS data delivery times.

26. The base station of claim 15, wherein the page monitoring interval controller configures the mobile station to operate with lower paging intervals at times corresponding to higher paging event probabilities by sending a monitoring interval profile to the mobile station, said monitoring interval profile comprising one or more monitoring interval settings that map to an incoming data arrival probability curve associated with the mobile station.

27. The base station of claim 26, wherein the page monitoring interval controller is configured to generate the monitoring interval profile as a set of monitoring interval values mapped to the incoming data arrival probability curve, such that the mobile station's page monitoring interval changes over time as a function of the incoming data arrival probability curve.

28. The base station of claim 15, wherein the page monitoring interval controller configures the mobile station to operate with lower page monitoring intervals at times corresponding to higher paging event probabilities by transferring a number of paging slot cycle index values to the mobile station, and information identifying times for operating at each one of the number of paging slot cycle index values, and wherein the number of paging slot cycle index values and times correspond to known or expected paging event probabilities.

29. The base station of claim 15, wherein the page monitoring interval controller configures the mobile station to operate with lower page monitoring intervals at times corresponding to higher paging event probabilities by transferring page monitoring interval configuration information to the mobile station in association with releasing a data connection of the mobile station.

30. The base station of claim 15, wherein the page monitoring interval controller configures the mobile station to operate with lower page monitoring intervals at times corresponding to higher paging event probabilities by transferring page monitoring interval configuration information to the mobile station while the mobile station is in an idle state.

31. The base station of claim 15, wherein the page monitoring interval controller determines times corresponding to higher paging event probabilities based on tracking one or more of mobile station call activity, base station call activity, and network call activity.
